(19) United States
(12) Patent Application Publication
(10) Pub. No.: US 2023/0073061 A1
(43) Pub. Date: Mar. 9, 2023

(54) MESH NETWORK UPDATE SYSTEM AND METHOD THEREOF

(71) Applicant: Realtek Singapore Private Limited, Singapore (SG)

(72) Inventor: Man-Chun Chow, Singapore (SG)

(21) Appl. No.: 17/510,485

(22) Filed: Oct. 26, 2021

(30) Foreign Application Priority Data
Sep. 3, 2021 (TW) 110132939

(51) Int. Cl. H04L 12/24

(52) U.S. Cl. CPC H04L 41/082; H04L 67/12

(57) ABSTRACT

A mesh network system includes a plurality of network nodes. The network nodes are communicatively connected to each other to form a mesh structure. The network nodes include a first node and at least one second node. The first node is configured to obtain an update file in response to an update trigger command and send an update notification to the at least one second node respectively. Each of the at least one second node is configured to obtain the update file from the first node in response to the update notification. The first node and the at least one second node perform an update procedure simultaneously according to the update file.

### CROSS-REFERENCE TO RELATED APPLICATION

This non-provisional application claims priority under 35 U.S.C. § 119(a) to Patent Application No. 11/013,2939 in Taiwan, R.O.C. on Sep. 3, 2021, the entire contents of which are hereby incorporated by reference.

### BACKGROUND

### Technical Field

The present invention relates to a network technology, and in particular, to a system and method for updating a mesh network.

### Related Art

Numerous devices capable of connecting to a network wirelessly or wiredly have emerged in our daily life, and there is an increasing demand for connection among a plurality of devices to form a local area network (LAN). However, due to factors such as the compatibility of some devices, the stability of the network, and the specifications of wireless or wired network standards, if a user wants to update data of hardware (for example, firmware update or function upgrade), the user can only update the networked devices one by one, and cannot update the networked devices synchronously.

### SUMMARY

In view of the above, the present invention provides a mesh network update system and a method thereof. According to some embodiments, by means of the present invention, devices connected a LAN can be synchronously updated. In some embodiments, by means of the present invention, the update costs can be reduced and the update efficiency can be improved merely by using a simple system and process.

According to some embodiments, the mesh network update system includes a plurality of network nodes. The network nodes are communicatively connected to each other to form a mesh structure. The network nodes include a first node and at least one second node. The first node is configured to obtain an update file in response to an update trigger command and send an update notification to the at least one second node respectively. Each of the at least one second node is configured to obtain the update file from the first node in response to the update notification. The first node and the at least one second node perform an update procedure synchronously according to the update file.

According to some embodiments, in a method for updating a mesh network, the mesh network includes a plurality of network nodes, and the network nodes are communicatively connected to each other to form a mesh structure. The network nodes include a first node and at least one second node. The method for updating a mesh network includes: obtaining, by the first node, an update file in response to an update trigger command; sending an update notification to the at least one second node respectively; sending the update file to the at least one second node respectively when the at least the one second node makes a response to the update notification; and performing an update procedure on the first node according to the update file upon receipt of the update file by the first node and the at least one second node, where the update procedure is synchronously performed by the at least one second node according to the update file.

In conclusion, according to some embodiments, in the mesh structure formed by the plurality of network nodes, the update procedure can be synchronously performed on the network nodes by using the update trigger command and the update notification. In some embodiments, since the mesh network update system is a simple structure, and the method for updating a mesh network is a simple process, the update costs can be reduced and the update efficiency can be improved.

### BRIEF DESCRIPTION OF THE DRAWINGS

FIG. 1 is a schematic structural diagram of a mesh network according to some embodiments of the present invention.

FIG. 2 is a schematic flowchart of a method for updating a mesh network according to some embodiments of the present invention.

FIG. 3 is a schematic diagram of application of a network node according to some embodiments of the present invention.

FIG. 4 is a schematic flowchart of a method for updating a mesh network according to some embodiments of the present invention.

FIG. 5 is a schematic flowchart of a method for updating a mesh network according to some embodiments of the present invention.

FIG. 6 is a schematic flowchart of a method for updating a mesh network according to some embodiments of the present invention.

FIG. 7 is a schematic flowchart of a method for updating a mesh network according to some embodiments of the present invention.

### DETAILED DESCRIPTION

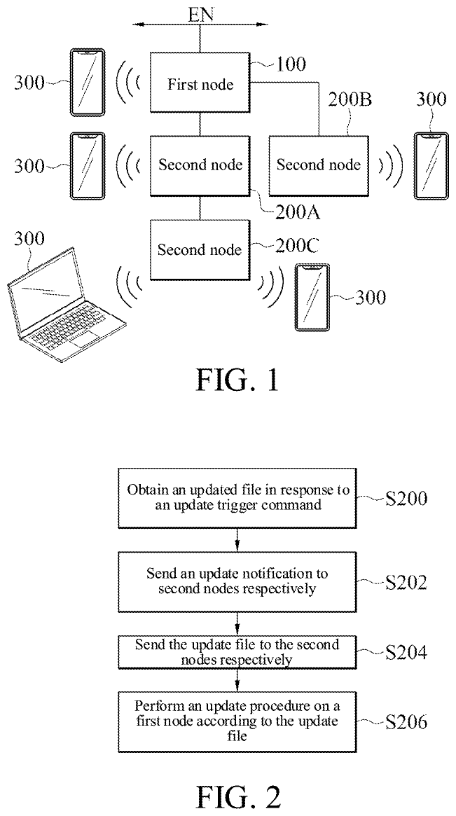

FIG. 1 is a schematic structural diagram of a mesh network according to some embodiments of the present invention. The mesh network is composed of a plurality of network nodes. The network nodes are communicatively connected to each other to form a mesh structure, and are connected to an external network EN by using a network topology of the mesh structure. The network nodes include a first node 100 and at least one second node. Although three second nodes 200A-200C are shown in FIG. 1, the present invention is not limited thereto. The quantity of the second nodes may be less than three or more than three according to user requirements. The mesh network is, for example, a wireless hotspot (Wi-Fi) easy mesh network. A network node is, for example, a device that has a packet forwarding function and a packet receiving function, such as a router or a gateway. The external network EN is, for example, a wide area network (WAN), and the mesh network may be a LAN. The communicative connection between the network nodes may be a wired communicative connection or a wireless communicative connection. The wireless communicative connection is, for example, a Wi-Fi communicative connection.

In some embodiments, each network node may be further communicatively connected to a terminal device 300, so that the terminal device 300 can be connected to the network. The terminal device 300 is, for example, a notebook computer, a desktop computer, a tablet computer, or a personal mobile device. The communicative connection between the network node and the terminal device 300 may be a wired communicative connection or a wireless communicative connection. The wireless communicative connection is, for example, a Wi-Fi communicative connection or a Bluetooth communicative connection.

FIG. 2 is a schematic flowchart of a method for updating a mesh network according to some embodiments of the present invention. The updating method is performed by the first node 100. First, the first node 100 obtains an update file in response to an update trigger command (step S200). The update file may be a firmware update file or a function upgrade file. In some embodiments, each network node includes a daemon module. The daemon module of the first node 100 is configured to obtain the update file by using the update trigger command, and trigger synchronous execution of an update procedure.

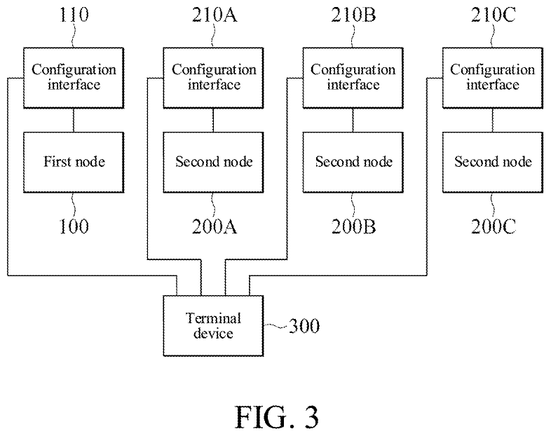

FIG. 3 is a schematic diagram of application of a network node according to some embodiments of the present invention. In some embodiments, the first node 100 obtains the update trigger command from a configuration interface 110. In some embodiments, the configuration interface 110 generates the update trigger command in response to an operation. In some embodiments, the configuration interface 110 may be a web page for detecting user operations. For example, as shown is FIG. 3, the web page (that is, the configuration interface 110) detects items selected on the web page by a user by using an input device (such as a keyboard, a mouse, or a touch screen) (not shown in the figure) or the terminal devices 300. The web page generates an update trigger command in response to a selected item (for example, a version number of a firmware update file for updating, or a function to be added or optimized). In some embodiments, the configuration interface 110 implemented by the web page is provided by the first node 100. In some embodiments, the configuration interface 110 may also be an input/output device for the user to input an update trigger command, and the configuration interface 110 may be configured inside or outside the first node 100.

Referring to FIG. 2 again, the first node 100 sends the update notification to the second nodes 200A to 200C respectively upon obtaining of the update file (step S202). For example, the daemon module of the first node 100 broadcasts the update notification to the daemon modules of the second nodes 200A to 200C synchronously or asynchronously, so that the second nodes 200A-200C learn that the first node 100 is to be updated.

The first node 100 sends an update file to the second nodes 200A-200C respectively when the second nodes 200A-200C make responses to the update notification (step S204). For example, when the daemon module of one of the second nodes (for example, 200A) makes a response to the update notification, the daemon module of the first node 100 sends the update file to the second node (that is, 200A).

When the first node 100 and the second nodes 200A-200C all obtain the update file, the first node 100 performs an update procedure according to the update file (step S206). The update procedure is synchronously performed by the second nodes 200A-200C according to the update file. That is to say, the first node 100 and the second nodes 200A-200C perform the update procedure synchronously according to the update file. In this way, all of the network nodes can perform the update procedure synchronously by using the update file of the same version, so as to reduce problems about compatibility between the network nodes as a result of different update time points or different update file versions (that is, incompatibility between the network nodes). In some embodiments, if the update file is a firmware update file, the update procedure is a firmware update procedure. In some other embodiments, if the update file is a function upgrade file, the update procedure is a function upgrade procedure. For example, new functions are added to the first node 100 and the second nodes 200A-200C or existing functions thereof are optimized.

In some embodiments, the update procedure begins when all of the network nodes have obtained the update file. In some embodiments, the update procedure may begin when the first node 100 and part of the second nodes 200A-200C have obtained the update file. In an example, the part of the second nodes 200A-200C may be nodes that are currently communicatively connected to the terminal device 300, and a user can use updated functions in real time by using the terminal device 300 (for example, after the updating, connection to the network is faster, that is, the terminal device 300 maintains an optimal network transmission speed). In another example, the part of the second nodes 200A-200C may be nodes that are not currently communicatively connected to the terminal device 300. In this way, disconnection of the terminal device 300 from the network as a result of the update procedure of the part of the second nodes 200A-200C can be prevented.

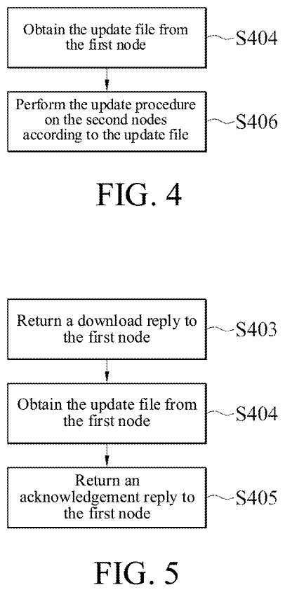

FIG. 4 is a schematic flowchart of a method for updating a mesh network according to some embodiments of the present invention. In some embodiments, the updating method is performed by the second nodes 200A-200C. The second nodes 200A-200C obtain the update file from the first node 100 in response to the update notification (step S404). For example, the second nodes 200A-200C obtain the update file from the first node 100 by using the respective daemon modules. Next, the second nodes 200A-200C perform the update procedure according to the update file (step S406). The update procedure is synchronously performed by the first node 100 according to the update file. That is to say, the first node 100 and the second nodes 200A-200C perform the update procedure synchronously according to the update file. In some embodiments, the updating method is jointly performed by the first node 100 and the second nodes 200A-200C.

In some embodiments, the second nodes 200A-200C perform a verification procedure upon obtaining of the update file, to determine whether the update file has been tampered with. If a verification result generated after the verification procedure is “verification succeeds”, the second nodes 200A-200C store the update file. If the verification result is “verification fails”, the second nodes 200A-200C each send a verification failure message to the first node 100, so that the first node 100 resends the update file to the second nodes 200A-200C. The verification procedure may be, for example, hash function verification or key encryption verification. The hash function verification may be algorithm verification, such as MD4, MD5, or SHA-1. The key encryption verification may be symmetric encryption verification or asymmetric encryption verification.

FIG. 5 is a schematic flowchart of a method for updating a mesh network according to some embodiments of the present invention. In some embodiments, each of the second nodes 200A-200C returns a download reply to the first node 100 upon receipt of the update notification (step S403). The download reply may include a download command, so that the first node 100 learns from the download command that the second nodes 200A-200C intend to obtain the update file. Since the first node 100 sends the update notification to the second nodes 200A-200C by means of broadcast, missing transmission may occur. In order to ensure that the second nodes 200A-200C receive the update notification, the download reply is used to notify the first node 100 that whether the update notification has been successfully transmitted to the second nodes 200A-200C. Upon successful transmission of the update notification to the second nodes 200A-200C, the first node 100 sends the update file to the second nodes 200A-200C respectively, so that the second nodes 200A-200C obtain the update file (step S404).

Each of the second nodes 200A-200C returns an acknowledgment reply to the first node 100 upon receipt of the update file (step S405). The first node 100 learns, according to the acknowledgment replies, whether the second nodes 200A-200C have successfully obtained the update file. When the first node 100 receives the acknowledgment reply from each of the second nodes 200A-200C (that is, when the first node 100 learns that the second nodes 200A-200C all have successfully obtained the update file), the first node 100 and the second nodes 200A-200C perform the update procedure synchronously according to the update file (step S406). By means of the acknowledgment reply, it is ensured that the first node 100 and the second nodes 200A-200C perform the update procedure synchronously.

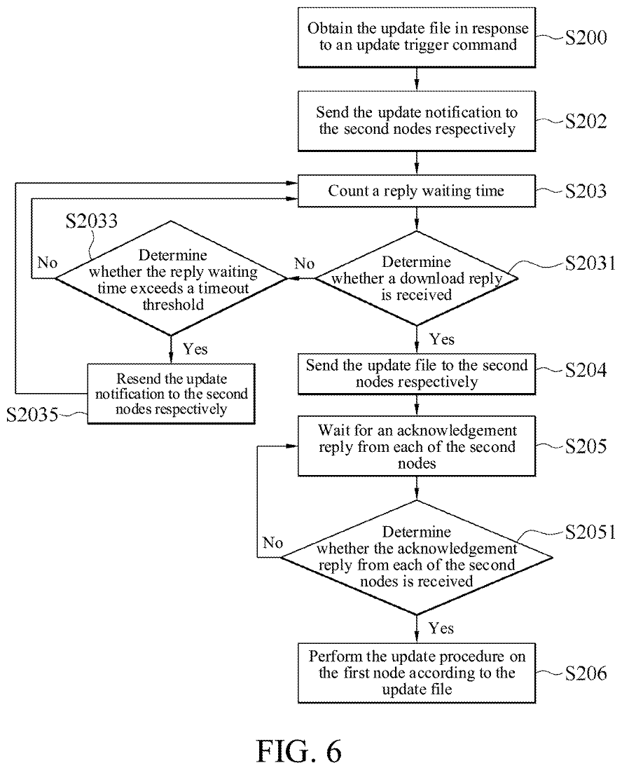

FIG. 6 is a schematic flowchart of a method for updating a mesh network according to some embodiments of the present invention. In some embodiments, the first node 100 counts a reply waiting time upon sending of the update notification (step S203). For example, the first node 100 counts the reply waiting time by using a timer. The timer may count time based on a clock frequency. Next, the first node 100 continuously waits for the download reply from the second nodes 200A-200C, and determines whether the download reply is received (step S2031). If the first node 100 receives the download reply, the first node 100 sends the update file to the second nodes 200A-200C respectively (step S204). For example, if the first node 100 receives the download reply sent by a second node (for example, 200A) upon receipt of the update notification, the first node 100 sends the update file to the second node (that is, 200A). If the first node 100 does not receive the download reply, the first node 100 determines whether the reply waiting time exceeds a timeout threshold (step S2033). For example, the first node 100 compares the reply waiting time with the timeout threshold by using a comparator, to determine whether the reply waiting time exceeds the timeout threshold.

When the reply waiting time exceeds the timeout threshold, the first node 100 resends the update notification to the second nodes 200A-200C (step S2035), and returns to step S203 to re-count the reply waiting time. For example, when the reply waiting time exceeds the timeout threshold and the first node 100 does not receive a download reply from a second node (for example, 200A), the first node 100 sends a new update notification to the second node (that is, 200A), and re-counts the reply waiting time.

When the reply waiting time does not exceed the timeout threshold, step S203 is performed, and the first node 100 continues to count the reply waiting time and continues to wait for the download reply. In other words, when the reply waiting time does not exceed the timeout threshold and the first node 100 receives the download reply, step S204 and subsequent steps are performed. Otherwise, step S2033 and subsequent steps are performed. Therefore, by means of the broadcast of the first node 100, it is ensured that each of the second nodes 200A-200C can receive the update notification.

In some embodiments, the timeout threshold may be inputted to the first node 100 by a user by using the terminal device 300 or the configuration interface 110. In some other embodiments, alternatively, the timeout threshold may also be pre-stored in the first node 100, avoiding to input the timeout threshold to the first node 100 every time step S2033 is to be performed. In some embodiments, the timeout threshold may be set by the user according to design requirements.

In some embodiments of step S204, a communication channel is established between the first node 100 and the second nodes 200A-200C according to a communication protocol. The communication protocol is, for example, a transmission control protocol. The first node 100 sends the update file to the second nodes 200A-200C through the communication channel. Before established, the communication channel undergoes a handshaking mechanism, so as to ensure that packets transmitted through the communication channel will not be lost, and the network nodes (such as, the second nodes 200A-200C), which are the receiver, can receive the packet (for example, the update file from the first node 100). In this way, the accuracy and the efficiency of transmission of the data can be improved. For example, it is unnecessary to count a time and set a time threshold to determine whether the second nodes 200A-200C receive the update file.

The first node 100 waits for the acknowledgment reply from each of the second nodes 200A-200C upon sending of the update file (step S205). Next, the first node 100 determines whether the first node receives the acknowledgment reply from each of the second nodes 200A-200C (step S2051). If the first node 100 receives the acknowledgment reply from each of the second nodes 200A-200C, step S206 is performed. If the first node 100 receives the acknowledgment reply from none of the second nodes 200A-200C, the first node returns to step S205 to continues to wait for the acknowledgment reply. In this way, it is ensured that the first node 100 and the second nodes 200A-200C perform the update procedure synchronously by using the update files of the same version.

In some embodiments, the update procedure may begin when the first node 100 and part of the second nodes 200A-200C have obtained the update file. That is to say, in some embodiments of step S2051, the first node 100 determines whether the first node receives the acknowledgment replies of part of the second nodes 200A-200C. When the first node 100 receives the acknowledgment replies from the part of the second nodes 200A-200C, step S206 is performed. Otherwise, step S205 is performed.

Referring to FIG. 3 again, in some embodiments, each network node corresponds to a different configuration interface. For example, the first node 100 corresponds to the configuration interface 110, and the second nodes 200A-200C correspond to configuration interfaces 210A-210C respectively. In some embodiments of step S206 and step S406, the first node 100 and the second nodes 200A-200C perform the update procedure synchronously by using the update file through the respective configuration interfaces 110 and 210A-210C. In this way, the first node 100 and the second nodes 200A-200C are preventing from interfering with each other's update procedures. In some embodiments, the configuration interface 210A-210C may be web pages and are provided by the second nodes 200A-200C respectively. In some embodiments, the configuration interfaces 210A-210C may be input/output devices, and are disposed inside or outside the second nodes 200A-200C respectively. The operation modes of the configuration interfaces 210A-210C are similar to that of the configuration interface 110. Therefore, details are not described herein again.

In some embodiments, each of the network nodes corresponds to a different configuration interface according to a different Internet Protocol (IP) address. For example, as shown in FIG. 3, in the same LAN domain, the first node 100 is communicatively connected to the configuration interface 110 by using an IP address “192.168.1.1”, and the second nodes 200A-200C are communicatively connected to the configuration interfaces 210A-210C by using IP addresses “192.168.1.3”, “192.168.1.5”, and “192.168.1.9” respectively. A user may log in to the configuration interfaces 110 and 210A-210C by using an IP address in the same network domain (for example, “192.168.1.12”) through the terminal device 300, so as to control the operations of the network nodes through the configuration interfaces 110 and 210A-210C.

In some embodiments, the user is required to input an account and a password to log in to the configuration interfaces 110 and 210A-210C. When the inputted account and password match user information pre-stored in the network nodes, the user can log in to the configuration interfaces 110 and 210A-210C and control the network nodes. The user information may be default setting information provided by a manufacturer for a device serving as a network node, or may be information set by a user after using the device serving as a network node. The user information may include a set account and a set password. In some embodiments, the user information may further include the personal information of the user. The personal information is, for example, a contact address, a name, or a phone number of the user.

In some embodiments, the user logs in to the different configuration interfaces 110 and 210A-210C with the same account and the same password. In some other embodiments, the user logs in to the different configuration interfaces 110 and 210A-210C with different accounts and corresponding passwords or with the same account but different passwords.

In some embodiments, the each network node has a configuration file. The configuration file is used to define a node type of the each network node. The configuration file may be a network topology configuration of the each network node. The node type includes a controller node type and an agent node type. For example, the mesh network is a Wi-Fi easy mesh network. In the specification of the Wi-Fi easy mesh network, the network nodes may be classified into a controller node (that is, a network node defined as the controller node type) and an agent node (that is, a network node defined as the agent node type). The controller node is configured to connect the agent node to the Wi-Fi easy mesh network and manage operations of the agent node. For example, the controller node manages an operation channel of the agent node, a data flow topology, and roaming of a user among network nodes. In some embodiments, an IP address of the controller node may be an assignable start address in a LAN domain. For example, in a LAN domain of “192.168.1.x”, since “192.168.1.0” has a specific purpose and is unassignable, the assignable start address is “192.168.1.1”. That is to say, the IP address of the controller node may be “192.168.1.1”.

In some embodiments, the node type of each network node may be selectively defined by a user. For example, before networking of the network nodes, the user inputs the configuration file to the network nodes through the terminal device 300, so that the network nodes can learn the node types thereof according to the configuration file (specifically, the network nodes determine, according to the configuration file, whether the network nodes are defined as the controller node type or the agent node type), and perform networking and maintain the mesh network.

In some embodiments, the update trigger command includes a header. The header is used to designate a network node as a receiver. In some embodiments, the header includes an IP address and/or node type information. The IP address in the header is used to indicate an IP address of a network node. The node type information in the header may be a media access control (MAC) address of a controller node and is used to indicate a MAC address of a network node.

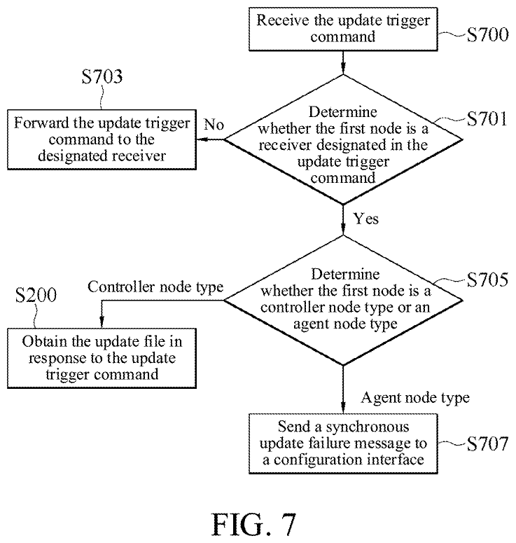

FIG. 7 is a schematic flowchart of a method for updating a mesh network according to some embodiments of the present invention. In some embodiments, after the first node 100 receives the update trigger command from the configuration interface 110 (step S700), the first node 100 determines, according to a header of the update trigger command, whether the first node is a receiver designated in the update trigger command (step S701). When the first node 100 is not the designated receiver, the first node 100 forwards the update trigger command to a network node designated as the receiver (step S703). That is to say, the first node 100 forwards the update trigger command to the network node indicated by the header. When the first node 100 is the designated receiver, the first node 100 determines, according to the configuration file, whether the first node is defined as a controller node type or an agent node type (step S705). That is to say, the first node 100 determines, according to the configuration file, whether the first node is a controller node or an agent node. When the first node 100 is defined as the controller node type (that is, the first node 100 is a controller node), step S200 and subsequent steps are performed. When the first node 100 is defined as the agent node type (that is, the first node 100 is an agent node), the first node 100 sends a synchronous update failure message to the configuration interface 110 (step S707). The configuration interface 110 learns, according to the synchronous update failure message, that the synchronous update fails, and sends the update trigger command to another first node (for example, one of other network nodes is selected as another first node). In this way, it can be ensured that the synchronous update procedure is triggered by the controller node.

In some embodiments, step S701 and step S703 may be omitted. In other words, after the first node 100 receives the update trigger command (step S700), the first node may directly determine whether the first node is a controller node or an agent node (step S705) and perform subsequent steps.

In some embodiments, since the operation of the agent node is managed by the controller node, the update notification and the update files can only be sent to the agent node by the controller node, and cannot be sent, by an agent node, to the controller node and other agent nodes. For example, only the controller node has the broadcast function, and the agent node does not have the broadcast function. In this way, the update notification can only be sent by the controller node. Therefore, upon receipt of the update trigger command, the first node 100 determines, according to the configuration file, whether the first node is the controller node, so as to learn whether the first node can perform the synchronous update procedure or not (for example, step S200 and subsequent steps). In other embodiments, each network node may send the update notification and the update file to other network nodes. For example, each network node has a broadcast function to send the update notification. Therefore, step S705 and step S707 of the first node 100 can be omitted, and when the first node 100 is the designated receiver, step S200 and subsequent steps are directly performed. In some embodiments, steps S701, S703, S705, and S707 may be omitted. That is to say, after the first node 100 receives the update trigger command (step S700), the first node may directly perform step S200 and the subsequent steps.

In some embodiments of step S701, the first node 100 determines whether the IP address corresponding to the first node matches the IP address in the header. If the IP address corresponding to the first node 100 matches the IP address in the header, it means that the first node 100 is the designated receiver, and step S705 is performed. If the IP address corresponding to the first node 100 does not match the IP address in the header, it means that the first node 100 is not the designated receiver, and the first node 100 forwards the update trigger command to the network node indicated by the IP address in the header (such as, another first node, and an IP address corresponding to the another first node matches the IP address in the header). Next, the indicated network node performs step S705 and subsequent steps. Therefore, by means of the IP address in the header, it is ensured that the update trigger command is received by the correct network node and that the synchronous update procedure is triggered by the correct controller node.

In some embodiments of step S701, the first node 100 determines whether a corresponding MAC address corresponding to the first node matches the MAC address in the header. If the MAC address corresponding to the first node 100 matches the MAC address in the header, it means that the first node 100 is the designated receiver, and step S705 is performed. If the MAC address corresponding to the first node 100 does not match the MAC address in the header, it means that the first node 100 is not the designated receiver, and the first node 100 forwards the update trigger command to the network node indicated by the MAC address in the header (such as, another first node, and a MAC address corresponding to the another first node matches the MAC address in the header). Next, the indicated network node performs step S705 and subsequent steps. Therefore, by means of the MAC address in the header, it is ensured that the update trigger command is received by the correct network node and that the synchronous update procedure is triggered by the correct controller node.

In conclusion, according to some embodiments, in the mesh structure formed by the plurality of network nodes, the update procedure can be synchronously performed on the network nodes by using the update trigger command and the update notification. In some embodiments, since the mesh network update system is a simple structure, and the method for updating a mesh network is a simple process, the update costs can be reduced and the update efficiency can be improved.

What is claimed is:

1. A mesh network system, comprising:
a plurality of network nodes, communicatively coupled to each other to form a mesh structure and comprising a first node and at least one second node, wherein
the first node is configured to obtain an update file in response to an update trigger command and send an update notification to the at least one second node respectively; and
each of the at least one second node is configured to obtain the update file from the first node in response to the update notification, and the first node and the at least one second node perform an update procedure substantially synchronously according to the update file.

2. The mesh network system according to claim 1, wherein each of the at least one second node returns a download reply to the first node upon receipt of the update notification.

3. The mesh network system according to claim 2, wherein the first node counts a reply waiting time and continuously waits for the download reply upon sending of the update notification, and the first node resends the update notification to the at least one second node when the reply waiting time exceeds a timeout threshold and the first node does not receive the download replies of the at least one second node.

4. The mesh network system according to claim 2, wherein the first node sends the update file to the at least one second node upon receipt of the download replies of the at least one second node.

5. The mesh network system according to claim 4, wherein each of the at least one second node returns an acknowledgment reply to the first node upon receipt of the update file, and the first node and the at least one second node perform the update procedure according to the update file upon receipt of the acknowledgment reply of the each of the at least one second node.

6. The mesh network system according to claim 1, wherein the first node has a configuration file, the first node determines, according to the configuration file, whether the first node is defined as a controller node type or an agent node type upon receipt of the update trigger command, and the first node obtains the update file in response to the update trigger command when the first node is defined as the controller node type and sends the update notification to the at least one second node respectively.

7. The mesh network system according to claim 6, wherein the first node sends a update failure message to a configuration interface when the first node is defined as the agent node type.

8. The mesh network system according to claim 6, wherein the first node obtains the update trigger command from a configuration interface, the configuration interface generates the update trigger command in response to an operation, the update trigger command comprises a header, the first node determines, according to the header, whether the first node is a receiver designated in the update trigger command, and the first node obtains the update file in response to the update trigger command when the first node is the designated receiver and the first node is defined as the controller node type and sends the update notification to the at least one second node respectively.

9. The mesh network system according to claim 1, wherein the first node and the at least one second node respectively correspond to a different configuration interface, and the first node and the at least one second node perform the update procedure by using respective configuration interfaces.

10. The mesh network system according to claim 9, wherein the first node and the at least one second node respectively correspond to a different configuration interface according to a different Internet Protocol (IP) address.

11. A method for updating a plurality of network nodes in a mesh network, wherein the network nodes comprise a first node and at least one second node, the method comprising:
obtaining, by the first node, an update file in response to an update trigger command;
sending an update notification to the at least one second node respectively;
sending the update file to the at least one second node respectively when the at least one second node makes a response to the update notification; and
performing an update procedure on the first node according to the update file upon receipt of the update file by the first node and the at least one second node, wherein the update procedure is substantially synchronously performed by the at least one second node according to the update file.

12. The method for updating a mesh network according to claim 11, wherein when the at least one second node sends a download reply respectively upon receipt of the update notification, the first node receives the download reply.

13. The method according to claim 12, wherein a reply waiting time is counted and the download reply is continuously waited upon sending of the update notification, and the update notification is resent to the at least one second node when the reply waiting time exceeds a timeout threshold and the first node does not receive the download replies of the at least one second node.

14. The method according to claim 12, wherein the first node sends the update file to the at least one second node upon receipt of the download replies of the at least one second node.

15. The method according to claim 14, wherein when the at least one second node respectively sends an acknowledgment reply upon receipt of the update file, the first node receives the acknowledgment replies of the at least one second node, and the update procedure is performed on the first node according to the update file upon receipt of the acknowledgment reply of each of the at least one second node by the first node, wherein the update procedure is performed by the at least one second node according to the update file.

16. The method according to claim 11, wherein the first node has a configuration file, and the method further comprises:
determining, according to the configuration file, whether the first node is defined as a controller node type or an agent node type upon receipt of the update trigger command; and
obtaining, by the first node, the update file in response to the update trigger command when the first node is defined as the controller node type, and sending the update notification to the at least one second node respectively.

17. The method according to claim 16 further comprises: sending a update failure message to a configuration interface when the first node is defined as the agent node type.

18. The method according to claim 16, wherein the first node obtains the update trigger command from a configuration interface, the configuration interface generates the update trigger command in response to an operation, the update trigger command comprises a header, and the method further comprises:
determining, according to the header, whether the first node is a receiver designated in the update trigger command, wherein
the first node obtains the update file in response to the update trigger command when the first node is the designated receiver and the first node is defined as the controller node type and sends the update notification to the at least one second node respectively.

19. The method according to claim 11, wherein the first node and the at least one second node respectively correspond to a different configuration interface, and the first node and the at least one second node perform the update procedure by using respective configuration interfaces.

20. The method according to claim 19, wherein the first node and the at least one second node respectively correspond to a different configuration interface according to a different IP address.
